(19) United States
(12) Patent Application Publication
(10) Pub. No.: US 2026/0004802 A1
(43) Pub. Date: Jan. 1, 2026

(54) MAGNETIC HEAD AND MAGNETIC RECORDING DEVICE

(71) Applicant: KABUSHIKI KAISHA TOSHIBA, Tokyo (JP)

(72) Inventors: Yuji NAKAGAMA, Kawasaki Kanagawa (JP); Satoshi SHIROTORI, Yokohama Kanagawa (JP); Yoshihiro HIGASHI, Komatsu Ishikawa (JP); Akira KITKITSU, Yokohama Kanagawa (JP)

(73) Assignee: KABUSHIKI KAISHA TOSHIBA, Tokyo (JP)

(21) Appl. No.: 19/233,026

(22) Filed: Jun. 10, 2025

(30) Foreign Application Priority Data
Jul. 1, 2024 (JP) 2024-106416

(51) Int. Cl. G11B 5/11; G11B 5/31

(52) U.S. Cl. CPC G11B 5/11; G11B 5/3143

(57) ABSTRACT

According to one embodiment, a magnetic head includes a reproducing section including a first reproducing element. The first reproducing element includes first to fourth shields, a first magnetic member, a first connection conductive, first to fifth terminals. The first magnetic member is provided between the first shield and the second shield, and between the third shield and the fourth shield. The first magnetic member includes first to fourth portions. The first terminal is electrically connected to the first portion. The second terminal is electrically connected to the second portion. The third terminal is electrically connected to the third portion. The fourth terminal is electrically connected to the fourth portion. The fifth terminal is electrically connected to the first connecting conductive member.

### CROSS-REFERENCE TO RELATED APPLICATIONS

This application is based upon and claims the benefit of priority from Japanese Patent Application No. 2024-106416, filed on Jul. 1, 2024; the entire contents of which are incorporated herein by reference.

### FIELD

Embodiments described herein relate generally to a magnetic head and a magnetic recording device.

### BACKGROUND

A magnetic head including a magnetic sensor using a magnetic layer is used to record information on a magnetic recording medium such as an HDD (Hard Disk Drive). Improved characteristics of the magnetic head are desired.

### BRIEF DESCRIPTION OF THE DRAWINGS

FIGS. 1A and 1B are schematic views illustrating a magnetic head according to a first embodiment;

FIG. 2 is a schematic cross-sectional view illustrating the magnetic head according to the first embodiment;

FIG. 3 is a schematic cross-sectional view illustrating a magnetic head according to the first embodiment;

FIG. 4 is a schematic cross-sectional view illustrating a magnetic head according to the first embodiment;

FIG. 5 is a schematic cross-sectional view illustrating a magnetic head according to the first embodiment;

FIG. 6 is a schematic cross-sectional view illustrating a magnetic head according to the first embodiment;

FIG. 7 is a schematic cross-sectional view illustrating a magnetic head according to the first embodiment;

FIG. 8 is a schematic cross-sectional view illustrating a magnetic head according to the first embodiment;

FIG. 9 is a schematic cross-sectional view illustrating a magnetic head according to the first embodiment;

FIGS. 10A and 10B are schematic views illustrating a magnetic head according to the first embodiment;

FIG. 11 is a schematic cross-sectional view illustrating a magnetic head according to the first embodiment;

FIG. 12 is a schematic cross-sectional view illustrating a magnetic head according to the first embodiment;

FIG. 13 is a schematic cross-sectional view illustrating a magnetic head according to the first embodiment;

FIG. 14 is a schematic cross-sectional view illustrating a magnetic head according to the first embodiment;

FIG. 15 is a schematic cross-sectional view illustrating a magnetic head according to the first embodiment;

FIG. 16 is a schematic cross-sectional view illustrating a magnetic head according to the first embodiment;

FIG. 17 is a schematic cross-sectional view illustrating a magnetic head according to the first embodiment;

FIG. 18 is a schematic perspective view illustrating a magnetic head and magnetic recording device according to the embodiment;

FIG. 19 is a schematic perspective view illustrating a part of the magnetic recording device according to the embodiment;

FIG. 20 is a schematic perspective view illustrating the magnetic recording device according to the embodiment; and

FIGS. 21A and 21B are schematic perspective views illustrating a part of the magnetic recording device according to the embodiment.

### DETAILED DESCRIPTION

According to one embodiment, a magnetic head includes a reproducing section including a first reproducing element. The first reproducing element includes a first shield, a second shield, a third shield, a fourth shield, a first magnetic member, a first connection conductive, a first terminal, a second terminal, a third terminal, a fourth terminal, and a fifth terminal. A second direction from the third shield to the fourth shield crosses a first direction from the first shield to the second shield. The first magnetic member is provided between the first shield and the second shield, and between the third shield and the fourth shield. The first magnetic member includes a first portion, a second portion, a third portion, and a fourth portion. The first portion is between the first shield and the second shield in the first direction. The second portion is between the first portion and the second shield in the first direction. The third portion is between the third shield and the fourth shield in the second direction. The fourth portion is between the third portion and the fourth shield in the second direction. The first connecting conductive member is electrically connected to the first magnetic member. A direction from at least a part of the first magnetic member to the first connecting conductive member is along a third direction crossing a plane including the first direction and the second direction. The first terminal is electrically connected to the first portion. The second terminal is electrically connected to the second portion. The third terminal is electrically connected to the third portion. The fourth terminal is electrically connected to the fourth portion. The fifth terminal is electrically connected to the first connecting conductive member.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

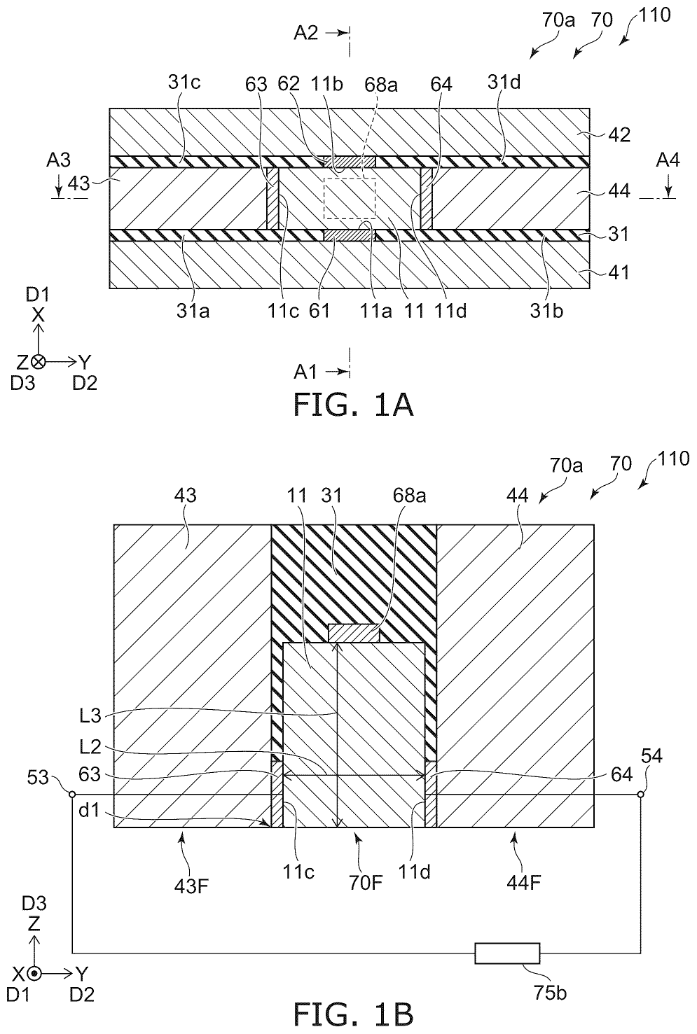

FIGS. 1A and 1B are schematic views illustrating a magnetic head according to a first embodiment.

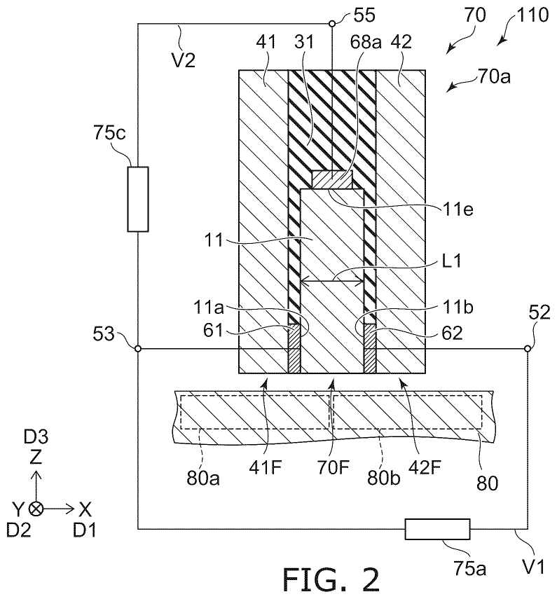

FIG. 2 is a schematic cross-sectional view illustrating the magnetic head according to the first embodiment.

FIG. 1A is a plan view. FIG. 1B is a cross-sectional view along the line A3-A4 in FIG. 1A. FIG. 2 is a cross-sectional view along the line A1-A2 in FIG. 1A.

As shown in FIG. 1, a magnetic head 110 according to the embodiment includes a reproducing section 70. The reproducing section 70 includes a first reproducing element 70a. The first reproducing element 70a includes a first shield 41, a second shield 42, a third shield 43, a fourth shield 44, a first magnetic member 11, a first connecting conductive member 68a, a first terminal 51, a second terminal 52, a third terminal 53, a fourth terminal 54, and a fifth terminal 55.

A second direction D2 from the third shield 43 to the fourth shield 44 crosses a first direction D1 from the first shield 41 to the second shield 42.

In this example, the first direction D1 is an X-axis direction. One direction perpendicular to the X-axis direction is defined as a Y-axis direction. A direction perpendicular to the X-axis and Y-axis directions is defined as a Z-axis direction. The second direction D2 is, for example, the Y-axis direction.

The X-axis direction corresponds, for example, to the down-track direction. The Y-axis direction corresponds, for example, to the cross-track direction. The Z-axis direction corresponds, for example, to the height direction.

The first magnetic member 11 is provided between the first shield 41 and the second shield 42, and between the third shield 43 and the fourth shield 44.

The first magnetic member 11 includes a first portion 11a, a second portion 11b, a third portion 11c, and a fourth portion 11d. The first portion 11a is between the first shield 41 and the second shield 42 in the first direction D1. The second portion 11b is between the first portion 11a and the second shield 42 in the first direction D1. The third portion 11c is between the third shield 43 and the fourth shield 44 in the second direction D2. The fourth portion 11d is between the third portion 11c and the fourth shield 44 in the second direction D2.

The first connecting conductive member 68a is electrically connected to the first magnetic member 11. The first connecting conductive member 68a may be non-magnetic. A direction from at least a part of the first magnetic member 11 to the first connecting conductive member 68a is along a third direction D3. The third direction D3 crosses a plane including the first direction D1 and the second direction D2. The third direction D3 is, for example, the Z-axis direction.

The first terminal 51 is electrically connected to the first portion 11a. The second terminal 52 is electrically connected to the second portion 11b. The third terminal 53 is electrically connected to the third portion 11c. The fourth terminal 54 is electrically connected to the fourth portion 11d. The fifth terminal 55 is electrically connected to the first connecting conductive member 68a.

In this example, the first reproducing element 70a further includes a first conductive member 61 and a second conductive member 62. The first conductive member 61 is provided between the first shield 41 and the first magnetic member 11. The first conductive member 61 may be non-magnetic. The second conductive member 62 is provided between the first magnetic member 11 and the second shield 42. The second conductive member 62 may be non-magnetic. The first conductive member 61 electrically connects the first shield 41 to the first portion 11a. The second conductive member 62 electrically connects the second shield 42 to the second portion 11b. The first terminal 51 may be electrically connected to the first portion 11a via the first shield 41 and the first conductive member 61. The second terminal 52 may be electrically connected to the second portion 11b via the second shield 42 and the second conductive member 62.

The first reproducing element 70a may further include a third conductive member 63 and a fourth conductive member 64. The third conductive member 63 is provided between the third shield 43 and the first magnetic member 11. The third conductive member 63 may be non-magnetic. The fourth conductive member 64 is provided between the first magnetic member 11 and the fourth shield 44. The fourth conductive member 64 may be non-magnetic. The third conductive member 63 electrically connects the third shield 43 to the third portion 11c. The fourth conductive member 64 electrically connects the fourth shield 44 to the fourth portion 11d. The third terminal 53 may be electrically connected to the third portion 11c via the third shield 43 and the third conductive member 63. The fourth terminal 54 may be electrically connected to the fourth portion 11d via the fourth shield 44 and the fourth conductive member 64.

In the embodiment, five or more terminals are provided. Thereby, the variety of signals that can be obtained from the magnetic recording medium can be increased. Information recorded on the magnetic recording medium can be reproduced more accurately. Thereby, it becomes easier to achieve high recording density, for example. According to the embodiment, a magnetic head can be provided that allows for improved characteristics.

For example, a current is supplied between the third terminal 53 and the fourth terminal 54. A first voltage V1 (first signal) between the first terminal 51 and the second terminal 52 is configured to change in response to the magnetic field to be detected when a current flows between the third terminal 53 and the fourth terminal 54. A second voltage V2 (second signal) between the first terminal 51 and the fifth terminal 55 is configured to change in response to the magnetic field to be detected when a current flows between the third terminal 53 and the fourth terminal 54. Such a change in voltage (electrical signal) is thought to be caused by, for example, the anomalous Hall effect.

For example, a current is supplied by a second circuit 75b. The first voltage V1 is detected by a first circuit 75a. The second voltage V2 is detected by a third circuit 75c. Thereby, it becomes possible to detect the magnetic field to be detected. The magnetic field to be detected is based on, for example, information recorded on a magnetic recording medium.

As shown in FIG. 2, the first reproducing element 70a includes a medium facing face 70F. The medium facing face 70F faces the magnetic recording medium 80. The first shield 41 includes a first end 41F corresponding to the medium facing face 70F. The second shield 42 includes a second end 42F corresponding to the medium facing face 70F. As shown in FIG. 1B, the third shield 43 includes a third end 43F corresponding to the medium facing face 70F. The fourth shield 44 includes a fourth end 44F corresponding to the medium facing face 70F.

A first distance in the third direction D3 between the first end 41F and the first conductive member 61 is shorter than a distance in the third direction D3 between the first end 41F and the first connecting conductive member 68a. A second distance in the third direction D3 between the second end 42F and the second conductive member 62 is shorter than a distance in the third direction D3 between the second end 42F and the first connecting conductive member 68a. A third distance in the third direction D3 between the third end 43F and the third conductive member 63 is shorter than a distance in the third direction D3 between the third end 43F and the first connecting conductive member 68a. A fourth distance in the third direction D3 between the fourth end 44F and the fourth conductive member 64 is shorter than a distance in the third direction D3 between the fourth end 44F and the first connecting conductive member 68a. The first to fourth distances may be zero.

A direction from the first conductive member 61 to the first connecting conductive member 68a crosses a direction from the first conductive member 61 to the second conductive member 62. In this example, the direction from the first conductive member 61 to the first connecting conductive member 68a is inclined with respect to the first direction D1. The direction from the first conductive member 61 to the second conductive member 62 is along the first direction D1.

For example, the first voltage V1 between the first terminal 51 electrically connected to the first conductive member 61 and the second terminal 52 electrically connected to the second conductive member 62 corresponds to, for example, the component of the characteristics of the first magnetic member 11 along the third direction D3.

The second voltage V2 between the first terminal 51 electrically connected to the first conductive member 61 and the fifth terminal 55 electrically connected to the first connecting conductive member 68a corresponds to, for example, a component of the characteristic of the first magnetic member 11 in a direction crossing the third direction D3. The second voltage V2 corresponds to, for example, a component of the characteristic of the first magnetic member 11 inclined with respect to the third direction D3.

In the embodiment, information is obtained regarding the component in the third direction D3 and the component crossing the third direction D3 (e.g., the component inclined with respect to the third direction D3). Thereby, the information recorded on the magnetic recording medium to be reproduced can be reproduced more accurately.

A direction from the third conductive member 63 to the first connecting conductive member 68a crosses a direction from the third conductive member 63 to the fourth conductive member 64. In this example, the direction from the third conductive member 63 to the first connecting conductive member 68a is inclined with respect to the second direction D2. The direction from the third conductive member 63 to the fourth conductive member 64 is along the second direction D2.

As shown in FIG. 2, the magnetic recording medium 80 includes a first recording region 80a and a second recording region 80b. A direction from the first recording region 80a to the second recording region 80b is, for example, along the first direction D1. The magnetic field to be detected by the first reproducing element 70a depends on the state of the first recording region 80a and the state of the second recording region 80b. For example, the second recording region 80b is next to the first recording region 80a in the down-track direction.

The magnetic recording r medium 80 may be a perpendicular magnetization film. For example, the first voltage V1 (first signal) corresponds to a first component along the third direction D3 of the magnetic field generated by the first magnetization of the first recording region 80a and the second magnetization of the second recording region 80b. The second voltage V2 (second signal) corresponds to a second component along the second direction D2 of the magnetic field generated by the first magnetization of the first recording region 80a and the second magnetization of the second recording region 80b. For example, the first voltage V1 (first signal) corresponds to, for example, the perpendicular component. The second voltage V2 (second signal) corresponds to, for example, the horizontal component.

In the example of the magnetic head 110, for example, the second circuit 75b includes a current source. For example, the first circuit 75a and the third circuit 75c include a voltmeter. At least a part of the first circuit 75a, the second circuit 75b, and the third circuit 75c may be considered to be included in the magnetic head 110 for convenience. At least a part of the first circuit 75a, the second circuit 75b, and the third circuit 75c may be provided separately from the magnetic head 110. These circuits may be included in the magnetic recording device.

In the embodiment, a current may be supplied between the first terminal 51 and the second terminal 52. For example, a voltage between the third terminal 53 and the fourth terminal 54 may be configured to change in response to the magnetic field to be detected when the current flows between the first terminal 51 and the second terminal 52. The voltage between the third terminal 53 and the fifth terminal 55 may be configured to change in response to the magnetic field to be detected when a current flows between the first terminal 51 and the second terminal 52.

The first magnetic member 11 has, for example, an anomalous Hall effect. For example, the first magnetic member 11 may include at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃. With these materials, for example, the anomalous Hall effect can be effectively obtained. The first magnetic member 11 may include a Weyl ferromagnet. The first magnetic member 11 may include an L1₀ ordered alloy. The first magnetic member 11 may include a Weyl antiferromagnet. The first magnetic member 11 may include an altermagnet.

In one example, at least one of the first conductive member 61, the second conductive member 62, the third conductive member 63, the fourth conductive member 64, or the first connecting conductive member 68a may include at least one selected from the group consisting of Cu, Au, Ag, Pt, Al, Pd, Ta, Ru, Hf, W, Mo, Ir, Cr, Tb, and Rh. These materials can, for example, suppress the effect of spin between the shield and the first magnetic member 11. High sensitivity is easily obtained.

As shown in FIG. 1A, in this example, in the first direction D1, the third shield 43 is between a part of the first shield 41 and a part of the second shield 42. In the first direction D1, the fourth shield 44 is between another part of the first shield 41 and another part of the second shield 42.

The first shield 41 is, for example, a leading shield. The second shield 42 is, for example, a trailing shield. The third shield 43 is at least a part of a side shield. The fourth shield 44 is at least a part of a side shield.

The first shield 41 is, for example, a bottom shield. The second shield 42 is, for example, a top shield. The third shield 43 is at least a part of the side bias layer. The fourth shield 44 is at least a part of the side bias layer.

As shown in FIG. 1A, the first reproducing element 70a may further include a first insulating member 31. The first insulating member 31 includes a first insulating region 31a and a second insulating region 31b. At least a part of the first insulating region 31a is provided between a part of the first shield 41 and the third shield 43. At least a part of the second insulating region 31b is provided between another part of the first shield 41 and the fourth shield 44.

As shown in FIGS. 1A and 1B, the first insulating member 31 may further include a third insulating region 31c and a fourth insulating region 31d. At least a part of the third insulating region 31c is provided between the third shield 43 and a part of the second shield 42. At least a part of the fourth insulating region 31d is provided between the fourth shield 44 and another part of the second shield 42.

As shown in FIGS. 1B and 2, a direction from the first magnetic member 11 to a part of the first insulating member 31 may be along the third direction D3. A part of the first insulating member 31 may be provided between the first shield 41 and the second shield 42. A part of the first insulating member 31 may be provided between the third shield 43 and the fourth shield 44.

As shown in FIG. 1B, a length of the first magnetic member 11 along the third direction D3 is defined as a length L3. A length of the first magnetic member 11 along the second direction D2 is defined as a length L2. For example, the length L3 may be longer than the length L2. For example, by shape anisotropy, a component of the magnetization of the first magnetic member 11 along the third direction D3 becomes larger. Thereby, it becomes easier to detect the magnetic field to be detected with higher sensitivity.

As shown in FIG. 2, a length of the first magnetic member 11 along the first direction D1 is defined as a length L1. For example, the length L3 may be longer than the length L1. For example, by shape anisotropy, the component of the magnetization of the first magnetic member 11 along the third direction D3 becomes large. Thereby, it becomes easier to detect the magnetic field to be detected with higher sensitivity.

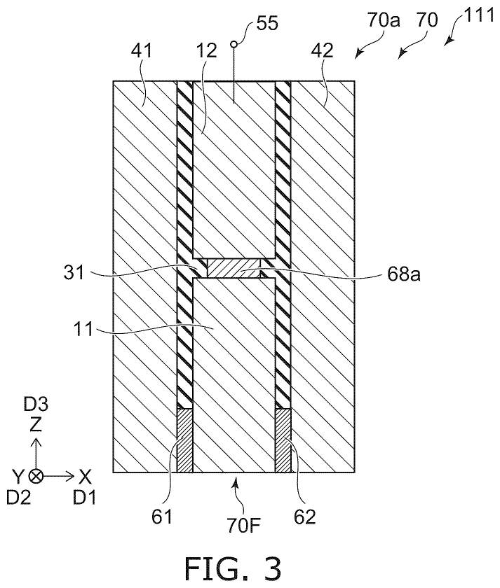

FIG. 3 is a schematic cross-sectional view illustrating a magnetic head according to the first embodiment.

As shown in FIG. 3, in a magnetic head 111 according to the embodiment, the first reproducing element 70a includes a second magnetic member 12. Except for this, the configuration of the magnetic head 111 may be the same as the configuration of the magnetic head 110.

In the magnetic head 111, the first reproducing element 70a includes the second magnetic member 12 in addition to the first magnetic member 11. A direction from the first magnetic member 11 to the second magnetic member 12 is along the third direction D3. The second magnetic member 12 includes, for example, IrMn. The magnetization of the first magnetic member 11 is stabilized by the second magnetic member 12. More stable reproduction becomes possible.

As in the example of the magnetic head 111, the first connecting conductive member 68a may be provided between the first magnetic member 11 and the second magnetic member 12 in the third direction D3. The fifth terminal 55 may be electrically connected to the first magnetic member 11 via the second magnetic member 12 and the first connecting conductive member 68a.

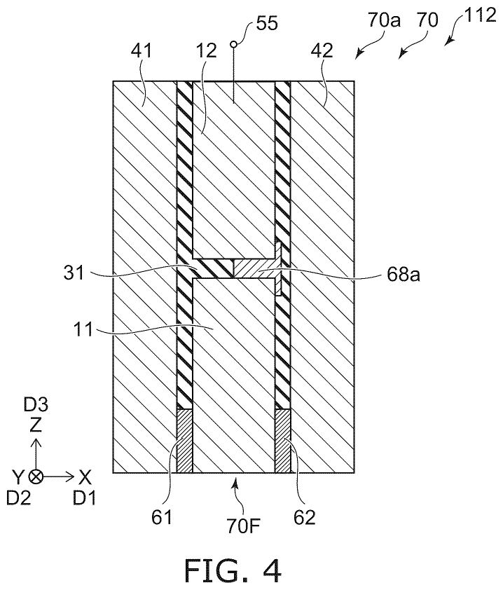

FIG. 4 is a schematic cross-sectional view illustrating a magnetic head according to the first embodiment.

As shown in FIG. 4, in a magnetic head 112 according to the embodiment, the configuration of the first connecting conductive member 68a is different from that in the magnetic head 111. Except for this, the configuration of the magnetic head 112 may be the same as the configuration of the magnetic head 111.

In the magnetic head 112, a distance in the first direction D1 between the first shield 41 and the first connecting conductive member 68a is longer than the distance in the first direction D1 between the second shield 42 and the first connecting conductive member 68a. For example, the reproducing characteristics in the down-track direction can be made asymmetric. For example, the signal in the second recording region 80b (see FIG. 2) can be made larger than the signal in the first recording region 80a (see FIG. 2).

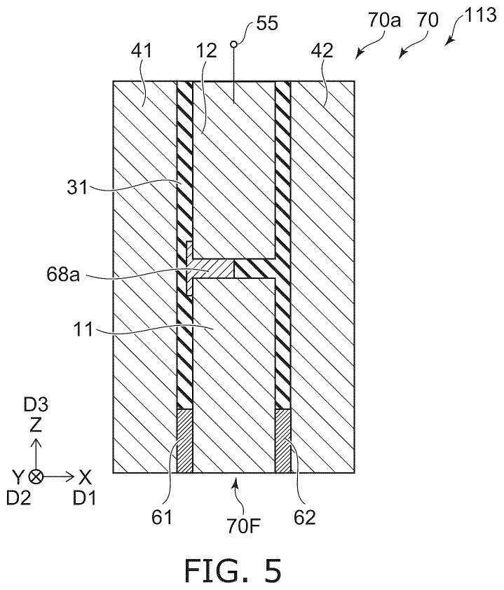

FIG. 5 is a schematic cross-sectional view illustrating a magnetic head according to the first embodiment.

As shown in FIG. 5, in a magnetic head 113 according to the embodiment, the configuration of the first connecting conductive member 68a is different from that in the magnetic head 112. Except for this, the configuration of the magnetic head 113 may be the same as the configuration of the magnetic head 112.

In the magnetic head 113, the distance in the first direction D1 between the first shield 41 and the first connecting conductive member 68a is shorter than the distance in the first direction D1 between the second shield 42 and the first connecting conductive member 68a. For example, the reproducing characteristics in the down-track direction can be made asymmetric. For example, the signal in the first recording region 80a (see FIG. 2) can be made larger than the signal in the second recording region 80b (see FIG. 2).

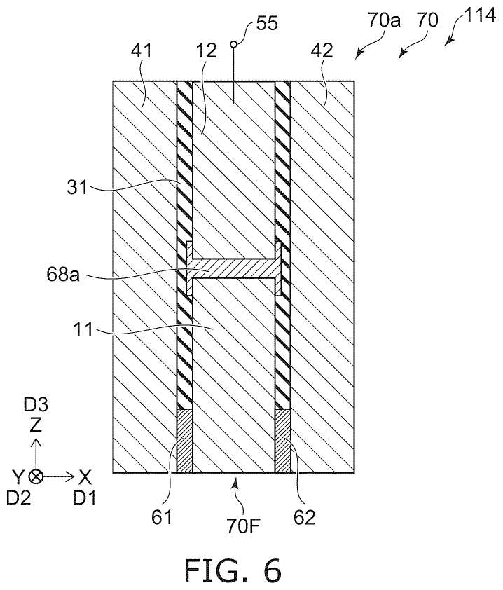

FIG. 6 is a schematic cross-sectional view illustrating a magnetic head according to the first embodiment.

As shown in FIG. 6, in a magnetic head 114 according to the embodiment, the configuration of the first connecting conductive member 68a is different from that in the magnetic head 110. Except for this, the configuration of the magnetic head 114 may be the same as the configuration of the magnetic head 110.

In the magnetic head 114, a part of the first connecting conductive member 68a is between the first magnetic member 11 and the second magnetic member 12 in the third direction D3. A part of the first magnetic member 11 is between a part of the first connecting conductive member 68a and another part of the first connecting conductive member 68a in the second direction D2. A part of the second magnetic member 12 is between a part of the first connecting conductive member 68a and another part of the first connecting conductive member 68a in the second direction D2.

In the magnetic heads 110 to 114, the first connecting conductive member 68a overlaps a part of the first magnetic member 11 in the third direction D3.

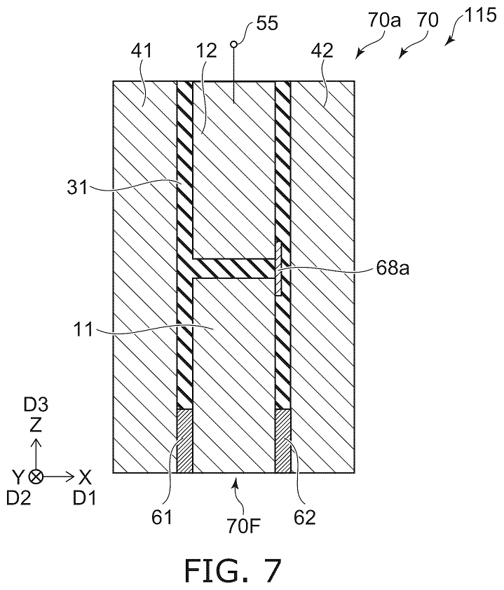

FIG. 7 is a schematic cross-sectional view illustrating a magnetic head according to the first embodiment.

As shown in FIG. 7, in a magnetic head 115 according to the embodiment, the configuration of the first connecting conductive member 68a is different from that in the magnetic head 110. Except for this, the configuration of the magnetic head 115 may be the same as the configuration of the magnetic head 110.

In the magnetic head 115, a part of the first connecting conductive member 68a is between the first magnetic member 11 and the second shield 42. Another part of the first connecting conductive member 68a is between the second magnetic member 12 and the second shield 42. The first connecting conductive member 68a is spaced apart from the second shield 42. The first connecting conductive member 68a is electrically connected to the first magnetic member 11 and the second magnetic member 12. A distance along the first direction D1 between the first shield 41 and the first connecting conductive member 68a is longer than a distance along the first direction D1 between the second shield 42 and the first connecting conductive member 68a.

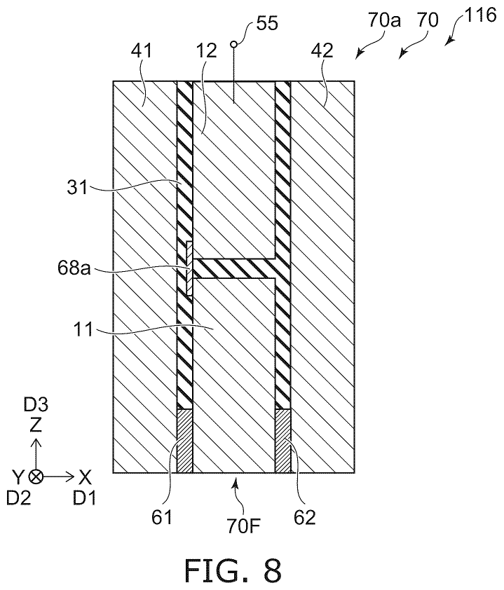

FIG. 8 is a schematic cross-sectional view illustrating a magnetic head according to the first embodiment.

As shown in FIG. 8, in a magnetic head 116 according to the embodiment, the configuration of the first connecting conductive member 68a is different from that in magnetic head 110. Except for this, the configuration of magnetic head 115 may be the same as the configuration of magnetic head 110.

In the magnetic head 116, a part of the first connecting conductive member 68a is between the first magnetic member 11 and the first shield 41. Another part of the first connecting conductive member 68a is between the second magnetic member 12 and the first shield 41. The first connecting conductive member 68a is separated from the first shield 41. The first connecting conductive member 68a is electrically connected to the first magnetic member 11 and the second magnetic member 12. The distance along the first direction D1 between the first shield 41 and the first connecting conductive member 68a is shorter than the distance along the first direction D1 between the second shield 42 and the first connecting conductive member 68a.

In the magnetic heads 111 to 116 above described, by the five terminals, more variety of signals can be obtained from the magnetic recording medium. For example, the first voltage V1 and the second voltage V2 can be obtained. Information recorded on the magnetic recording medium can be detected more accurately. Thereby, it becomes easier to obtain a high recording density, for example. A magnetic head can be provided that allows for improved characteristics.

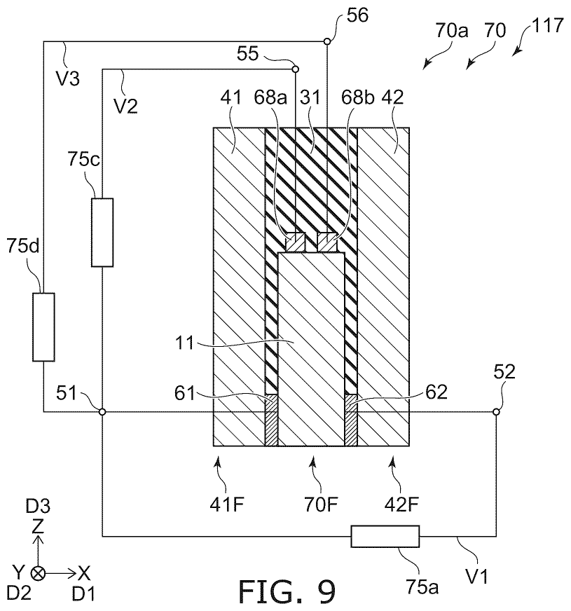

FIG. 9 is a schematic cross-sectional view illustrating a magnetic head according to the first embodiment.

As shown in FIG. 9, in a magnetic head 117 according to the embodiment, the first reproducing element 70a includes a second connecting conductive member 68b. Except for this, the configuration of the magnetic head 117 may be the same as the configuration of the magnetic head 110.

In the magnetic head 117, the first reproducing element 70a includes the second connecting conductive member 68b and a sixth terminal 56. The second connecting conductive member 68b is electrically connected to the first magnetic member 11. The second connecting conductive member 68b may be non-magnetic. The sixth terminal 56 is electrically connected to the second connecting conductive member 68b. For example, a direction from the first connecting conductive member 68a to the second connecting conductive member 68b crosses the third direction D3. In this example, the direction from the first connecting conductive member 68a to the second connecting conductive member 68b is along the first direction D1.

For example, by processing the signal (voltage signal) obtained from the sixth terminal 56, the information recorded on the magnetic recording medium 80 can be reproduced with higher accuracy.

For example, a third voltage V3 (third signal) between the first terminal 51 and the sixth terminal 56 may be configured to change according to the magnetic field to be detected when a current flows between the third terminal 53 and the fourth terminal 54.

A fourth circuit 75d may be provided. The fourth circuit 75d may be configured to detect, for example, the third voltage V3 between the first terminal 51 and the sixth terminal 56. In the embodiment, information recorded on the magnetic recording medium 80 may be reproduced by processing at least two of the first voltage V1, the second voltage V2, and the third voltage V3.

In the magnetic heads 110 to 117 described above, a fourth voltage V4 between the third terminal 53 and the fourth terminal 54 may be configured to change according to the magnetic field to be detected when a current flows between the third terminal 53 and the fourth terminal 54. Such a change in voltage (electrical signal) may be caused by, for example, at least one of the anisotropic magnetoresistance effect and the giant magnetoresistance effect. In the embodiment, information recorded on the magnetic recording medium 80 may be reproduced by processing at least two of the first voltage V1, the second voltage V2, the third voltage V3, and the fourth voltage V4.

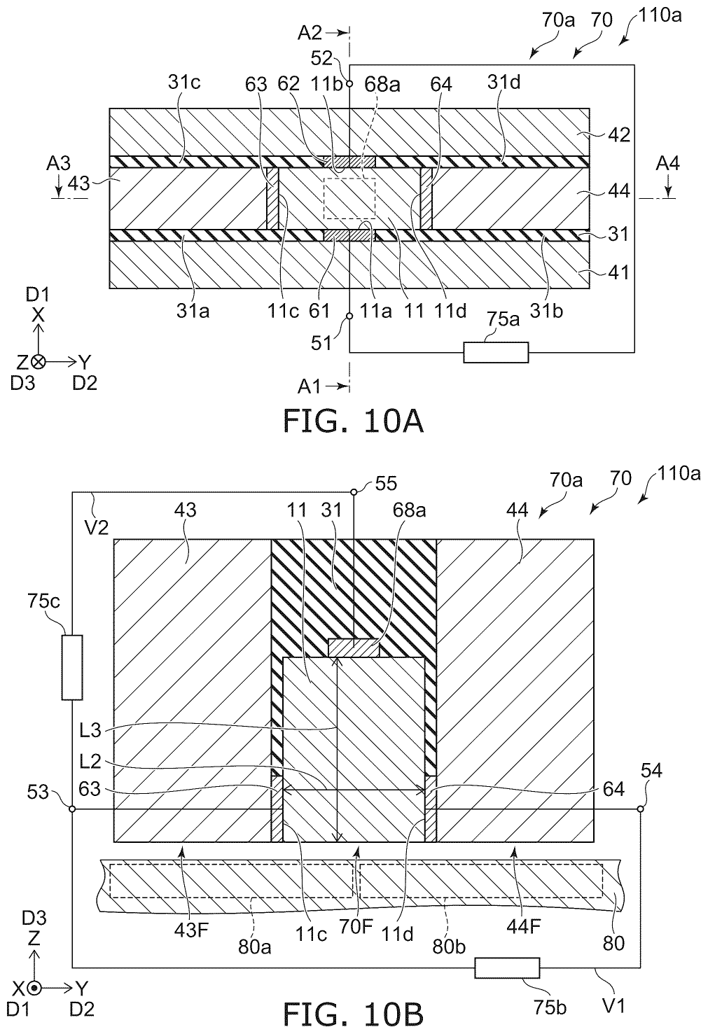

FIGS. 10A and 10B are schematic views illustrating a magnetic head according to the first embodiment.

FIG. 10A is a plan view. FIG. 10B is a cross-sectional view taken along the line A3-A4 in FIG. 10A.

As shown in FIGS. 10A and 10B, a magnetic head 110a according to the embodiment includes the reproducing section 70. The reproducing section 70 includes the first reproducing element 70a. In the magnetic head 110a, the third circuit 75c is connected between the third terminal 53 and the first connecting conductive member 68a. Except for this, the configuration of the magnetic head 110a may be the same as the configuration of the magnetic head 110. For example, the structure illustrated in FIG. 2 may be applied to the magnetic head 110a.

In the magnetic head 110a, for example, the first voltage V1 (first signal) between the third terminal 53 and the fourth terminal 54 is configured to change in response to the magnetic field to be detected when a current flows between the first terminal 51 and the second terminal 52. For example, the second voltage V2 between the third terminal 53 and the fifth terminal 55 is configured to change in response to the magnetic field to be detected when a current flows between the first terminal 51 and the second terminal 52.

For example, in this example, the first circuit 75a includes a current source. The second circuit 75b and the third circuit 75c include a voltmeter. For example, a more variety of signals can be obtained from the magnetic recording medium. Information recorded on the magnetic recording medium can be reproduced more accurately. Thereby, it becomes easier to obtain a high recording density, for example. A magnetic head can be provided that allows for improved characteristics.

A direction from the third conductive member 63 to the first connecting conductive member 68a crosses the direction from the third conductive member 63 to the fourth conductive member 64. In this example, the direction from the third conductive member 63 to the first connecting conductive member 68a is inclined with respect to the second direction D2. The direction from the third conductive member 63 to the fourth conductive member 64 is along the second direction D2. In the magnetic head 110a, information regarding the component of the third direction D3 and the component crossing the third direction D3 (for example, a component inclined with respect to the third direction D3) can be obtained. Thereby, information recorded on the magnetic recording medium to be reproduced can be reproduced more accurately.

As shown in FIG. 10B, the magnetic recording medium 80 includes a first recording region 80a and a second recording region 80b. The direction from the first recording region 80a to the second recording region 80b crosses the third direction D3. In this example, the direction from the first recording region 80a to the second recording region 80b is along the second direction D2. The magnetic field to be detected by the first reproducing element 70a depends on the state of the first recording region 80a and the state of the second recording region 80b. For example, the second recording region 80b is next to the first recording region 80a in the cross-track direction.

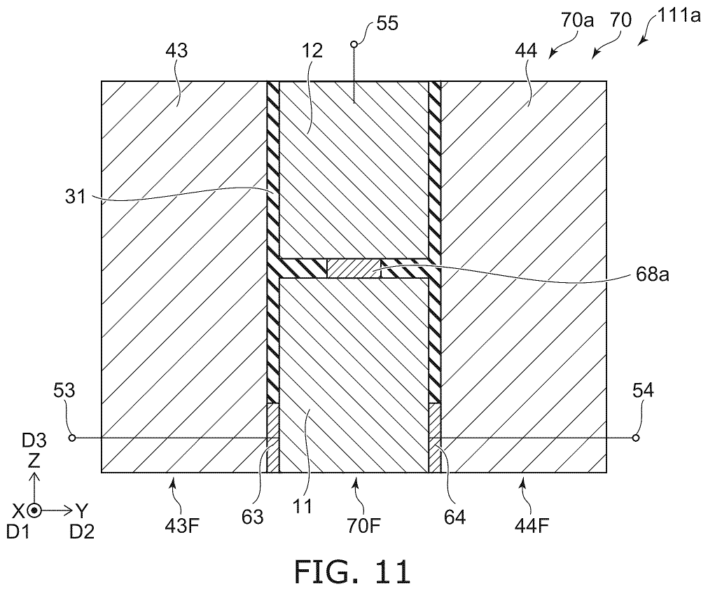

FIG. 11 is a schematic cross-sectional view illustrating a magnetic head according to the first embodiment.

As shown in FIG. 11, in a magnetic head 111a according to the embodiment, the first reproducing element 70a includes the second magnetic member 12. Except for this, the configuration of the magnetic head 111a may be the same as the configuration of the magnetic head 110a.

In the magnetic head 111a, the direction from the first magnetic member 11 to the second magnetic member 12 is along the third direction D3. The second magnetic member 12 includes, for example, IrMn. By the second magnetic member 12, the magnetization of the first magnetic member 11 is stabilized. More stable reproduction is possible.

As in the example of magnetic head 111a, the first connecting conductive member 68a may be provided between the first magnetic member 11 and the second magnetic member 12 in the third direction D3. The fifth terminal 55 may be electrically connected to the first magnetic member 11 via the second magnetic member 12 and the first connecting conductive member 68a.

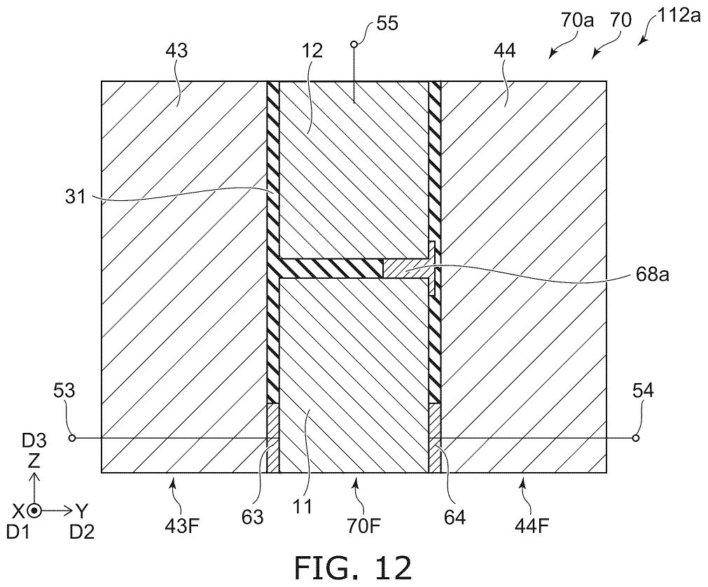

FIG. 12 is a schematic cross-sectional view illustrating a magnetic head according to the first embodiment.

As shown in FIG. 12, in a magnetic head 112a according to the embodiment, the configuration of the first connecting conductive member 68a is different from that in the magnetic head 111a. Except for this, the configuration of the magnetic head 112a may be the same as the configuration of the magnetic head 111a.

In the magnetic head 112a, a distance in the second direction D2 between the third shield 43 and the first connecting conductive member 68a is longer than a distance in the second direction D2 between the fourth shield 44 and the first connecting conductive member 68a. For example, the reproducing characteristics in the cross-track direction can be made asymmetric.

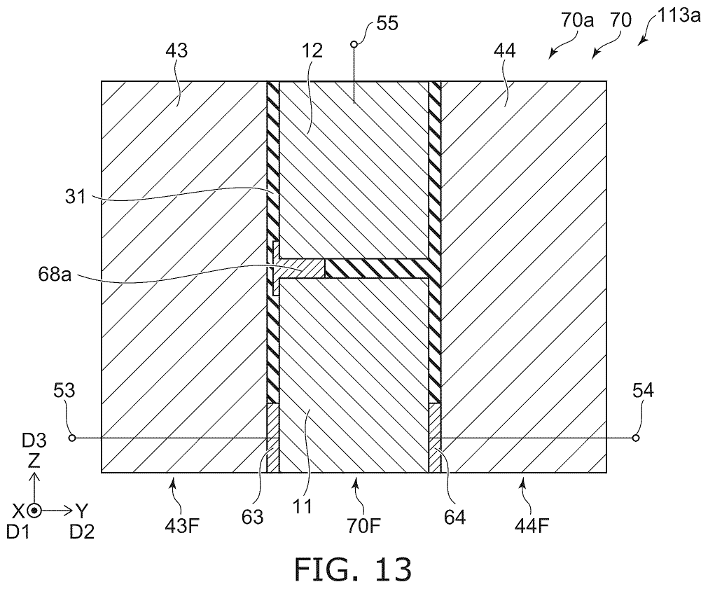

FIG. 13 is a schematic cross-sectional view illustrating a magnetic head according to the first embodiment.

As shown in FIG. 13, in a magnetic head 113a according to the embodiment, the configuration of the first connecting conductive member 68a is different from that in the magnetic head 112a. Except for this, the configuration of the magnetic head 113a may be the same as the configuration of the magnetic head 112a.

In the magnetic head 113a, the distance in the second direction D2 between the third shield 43 and the first connecting conductive member 68a is shorter than the distance in the second direction D2 between the fourth shield 44 and the first connecting conductive member 68a. For example, the reproducing characteristics in the cross-track direction can be made asymmetric.

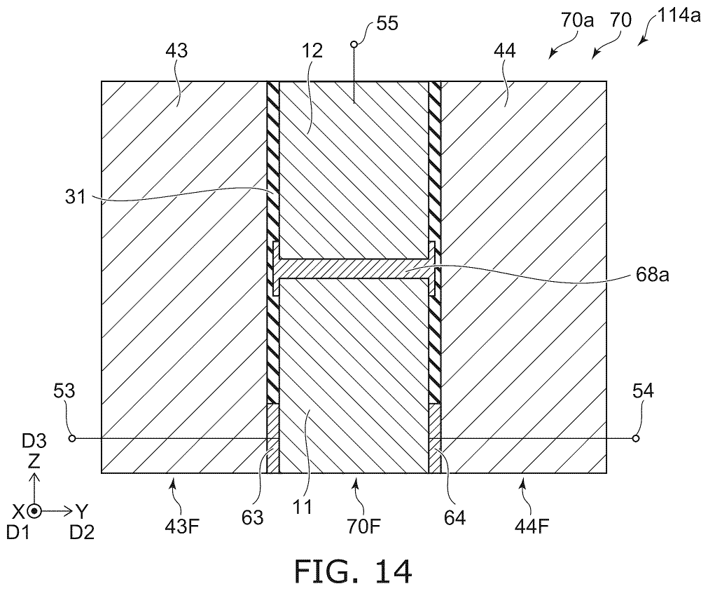

FIG. 14 is a schematic cross-sectional view illustrating a magnetic head according to the first embodiment.

As shown in FIG. 14, in a magnetic head 114a according to the embodiment, the configuration of the first connecting conductive member 68a is different from that in magnetic head 110a. Except for this, the configuration of magnetic head 114a may be the same as the configuration of magnetic head 110a.

In the magnetic head 114a, a part of the first connecting conductive member 68a is between the first magnetic member 11 and the second magnetic member 12 in the third direction D3. A part of the first magnetic member 11 is between a part of the first connecting conductive member 68a and another part of the first connecting conductive member 68a in the second direction D2. A part of the second magnetic member 12 is between a part of the first connecting conductive member 68a and another part of the first connecting conductive member 68a in the second direction D2.

In the magnetic heads 110a to 114a, the first connecting conductive member 68a overlaps a part of the first magnetic member 11 in the third direction D3.

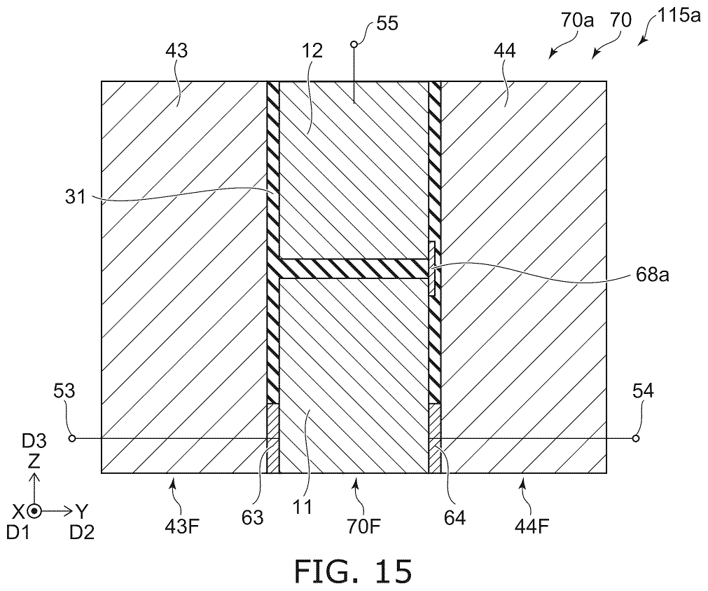

FIG. 15 is a schematic cross-sectional view illustrating a magnetic head according to the first embodiment.

As shown in FIG. 15, in a magnetic head 115a according to the embodiment, the configuration of the first connecting conductive member 68a is different from that in magnetic head 110a. Except for this, the configuration of magnetic head 115a may be the same as the configuration of magnetic head 110a.

In the magnetic head 115a, a part of the first connecting conductive member 68a is between the first magnetic member 11 and the fourth shield 44. Another part of the first connecting conductive member 68a is between the second magnetic member 12 and the fourth shield 44. The first connecting conductive member 68a is spaced from the fourth shield 44. The first connecting conductive member 68a is electrically connected to the first magnetic member 11 and the second magnetic member 12. The distance along the second direction D2 between the third shield 43 and the first connecting conductive member 68a is longer than the distance along the second direction D2 between the second shield 42 and the first connecting conductive member 68a.

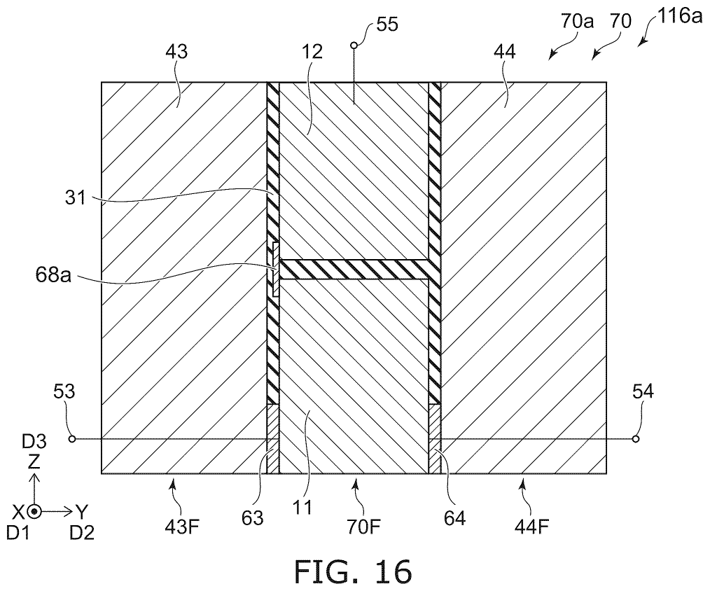

FIG. 16 is a schematic cross-sectional view illustrating a magnetic head according to the first embodiment.

As shown in FIG. 16, in a magnetic head 116a according to the embodiment, the configuration of the first connecting conductive member 68a is different from that in magnetic head 110a. Except for this, the configuration of magnetic head 115a may be the same as the configuration of magnetic head 110a.

In the magnetic head 116a, a part of the first connecting conductive member 68a is between the first magnetic member 11 and the third shield 43. Another part of the first connecting conductive member 68a is between the second magnetic member 12 and the third shield 43. The first connecting conductive member 68a is spaced apart from the third shield 43. The first connecting conductive member 68a is electrically connected to the first magnetic member 11 and the second magnetic member 12. The distance along the second direction D2 between the third shield 43 and the first connecting conductive member 68a is shorter than the distance along the second direction D2 between the fourth shield 44 and the first connecting conductive member 68a.

In the magnetic heads 111a to 116a described above, by the five terminals, more variety of signals to be obtained from the magnetic recording medium can be obtained. For example, the first voltage V1 and the second voltage V2 can be obtained. Information recorded on the magnetic recording medium can be detected more accurately. Thereby, it becomes easier to obtain a high recording density, for example. A magnetic head can be provided that allows for improved characteristics.

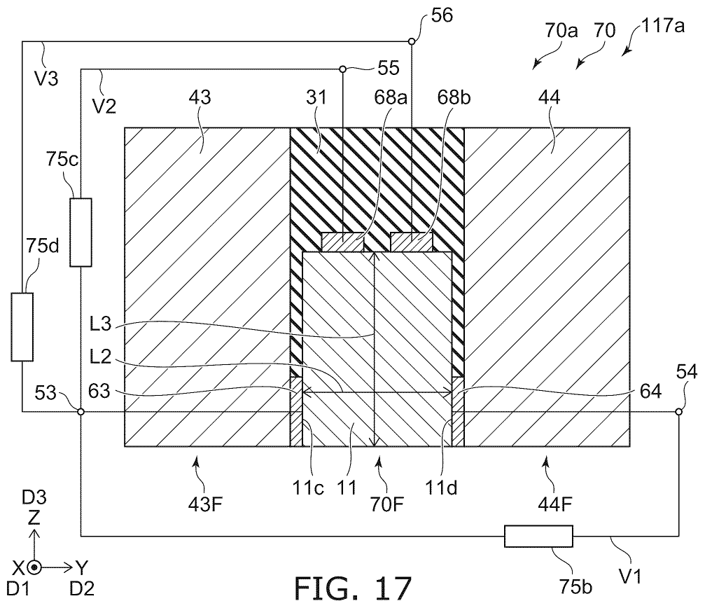

FIG. 17 is a schematic cross-sectional view illustrating a magnetic head according to the first embodiment.

As shown in FIG. 17, in a magnetic head 117a according to the embodiment, the first reproducing element 70a includes the second connecting conductive member 68b. Except for this, the configuration of magnetic head 117a may be the same as the configuration of magnetic head 110a.

In the magnetic head 117a, the second connecting conductive member 68b is electrically connected to the first magnetic member 11. The second connecting conductive member 68b may be non-magnetic. The sixth terminal 56 is electrically connected to the second connecting conductive member 68b. For example, the direction from the first connecting conductive member 68a to the second connecting conductive member 68b crosses the third direction D3. In this example, the direction from the first connecting conductive member 68a to the second connecting conductive member 68b is along the second direction D2.

For example, by processing the signal (voltage signal) obtained from the sixth terminal 56, the information recorded on the magnetic recording medium 80 can be reproduced with higher accuracy.

For example, the third voltage V3 (third signal) between the third terminal 53 and the sixth terminal 56 may be configured to change according to the magnetic field to be detected when a current flows between the first terminal 51 and the second terminal 52.

The fourth circuit 75d may be provided. The fourth circuit 75d may be configured to detect, for example, the third voltage V3 between the third terminal 53 and the sixth terminal 56. In the embodiment, information recorded on the magnetic recording medium 80 may be reproduced by processing at least two of the first voltage V1, the second voltage V2, and the third voltage V3.

In the magnetic heads 110a to 117a described above, the fourth voltage V4 between the first terminal 51 and the second terminal 52 may be configured to change according to the magnetic field to be detected when a current flows between the first terminal 51 and the second terminal 52. In the embodiment, information recorded on the magnetic recording medium 80 may be reproduced by processing at least two of the first voltage V1, the second voltage V2, the third voltage V3, and the fourth voltage V4.

FIG. 18 is a schematic perspective view illustrating a magnetic head and magnetic recording device according to the embodiment.

As shown in FIG. 18, the magnetic head (e.g., magnetic head 110) according to the embodiment includes the reproducing section 70. The reproducing section 70 includes the first reproducing element 70a. The reproducing section 70 may further include other reproducing elements. The magnetic head 110 is used together with the magnetic recording medium 80. The magnetic head 110 may include a recording section 90. Information is recorded on the magnetic recording medium 80 by the recording section 90 of the magnetic head 110. The information recorded on the magnetic recording medium 80 is reproduced by the reproducing section 70.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element or a high-frequency oscillation element. The recording section element 93 may be omitted.

The first reproducing element 70a of the reproducing section 70 includes, for example, the first shield 41, the second shield 42, and the first magnetic member 11. In FIG. 18, the third shield 43 and the fourth shield 44 are omitted. The reproducing section 70 can output a signal corresponding to the magnetization 83 of the magnetic recording layer 81.

As shown in FIG. 18, the magnetic recording medium 80 moves relative to the magnetic head 110 in a medium movement direction 85. The magnetic head 110 controls information corresponding to the magnetization 83 of the magnetic recording layer 81 at desired position. The magnetic head 110 reproduces information corresponding to the magnetization 83 of the magnetic recording layer 81 at desired position.

For example, the medium movement direction 85 may be from the first shield 41 to the second shield 42. For example, the magnetic recording medium 80 includes one recording region (first region). After the first region faces the first shield 41, the first region faces the second shield 42.

For example, a direction from the reproducing section 70 to the recording section 90 is along the first direction D1. For example, the second shield 42 is between the first magnetic member 11 and the recording section 90. For example, the second conductive member 62 is between the first magnetic member 11 and the recording section 90.

The magnetic recording device according to the embodiment includes the above-mentioned magnetic head (e.g., magnetic head 110), the magnetic recording medium 80, and the first circuit 75a, the second circuit 75b, and the third circuit 75c. The reproducing section 70 is configured to reproduce information recorded on the magnetic recording medium 80. One of the first circuit 75a and the second circuit 75b is configured to supply a current between the first terminal 51 and the second terminal 52. The other of the first circuit 75a and the second circuit 75b is configured to detect the first voltage V1 between the third terminal 53 and the fourth terminal 54. In one example, the third circuit 75c is configured to detect the second voltage V2 between the first terminal 51 and the fifth terminal 55. In another example, the third circuit 75c is configured to detect the second voltage V2 between the third terminal 53 and the fifth terminal 55.

For example, the reproducing section 70 (first reproducing element 70a) faces the magnetic recording medium 80. The magnetic recording medium 80 may include the first recording region 80a and the second recording region 80b. The direction from the first recording region 80a to the second recording region 80b is along the first direction D1 or the second direction D2. The reproducing section 70 may be configured to reproduce the state of the first recording region 80a and the state of the second recording region 80b.

The magnetic recording device may include the fourth circuit 75d. The fourth circuit 75d may be configured to detect, for example, the third voltage V3 between the third terminal 53 and the sixth terminal 56. In the embodiment, information recorded on the magnetic recording medium 80 may be reproduced by processing at least two of the first voltage V1, the second voltage V2, and the third voltage V3.

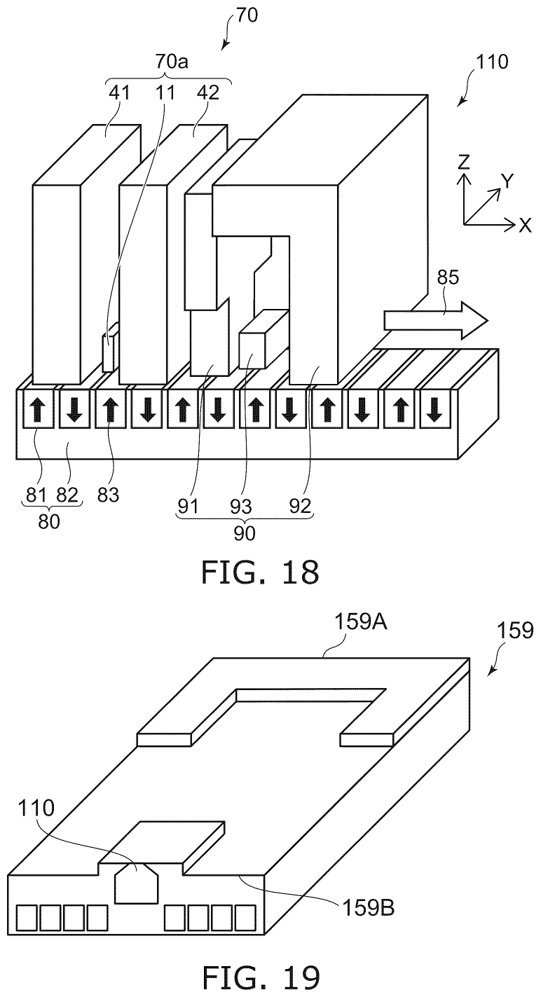

FIG. 19 is a schematic perspective view illustrating a part of the magnetic recording device according to the embodiment.

FIG. 19 illustrates a head slider.

The magnetic head 110 is provided on the head slider 159. The head slider 159 includes, for example, Al₂O₃/TiC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side surface of the air outflow side 159B of the head slider 159 or the like. As a result, the magnetic head 110 moves relative to the magnetic recording medium while flying above or in contact with the magnetic recording medium.

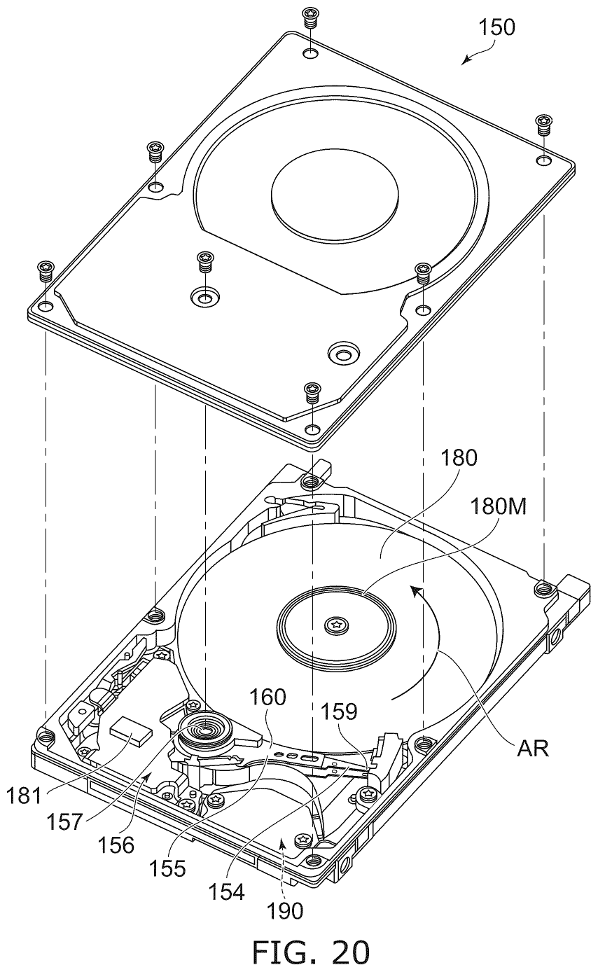

FIG. 20 is a schematic perspective view illustrating the magnetic recording device according to the embodiment.

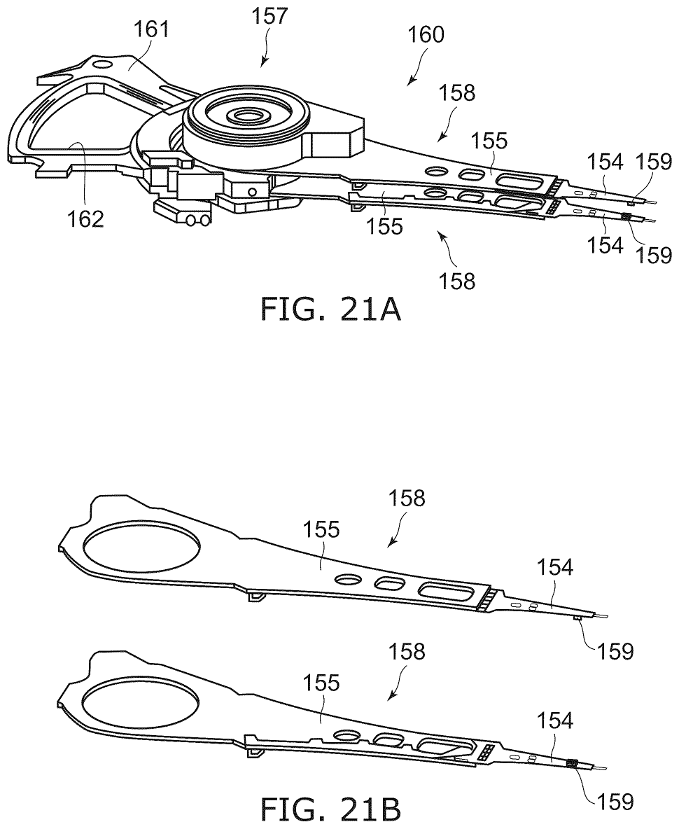

FIGS. 21A and 21B are schematic perspective views illustrating a part of the magnetic recording device according to the embodiment.

As shown in FIG. 20, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 21A is an enlarged perspective view of the head stack assembly 160, illustrating the configuration of a part of the magnetic recording device.

FIG. 21B is a perspective view illustrating the magnetic head assembly (head gimbal assembly: HGA) 158 that forms part of the head stack assembly 160.

As shown in FIG. 21A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 21B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical Proposal 1

A magnetic head, comprising:
a reproducing section including a first reproducing element,
the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield, the first magnetic member including a first portion, a second portion, a third portion, and a fourth portion, the first portion being between the first shield and the second shield in the first direction, the second portion being between the first portion and the second shield in the first direction, the third portion being between the third shield and the fourth shield in the second direction, and the fourth portion being between the third portion and the fourth shield in the second direction;
a first connecting conductive member electrically connected to the first magnetic member, a direction from at least a part of the first magnetic member to the first connecting conductive member being along a third direction crossing a plane including the first direction and the second direction;
a first terminal electrically connected to the first portion;
a second terminal electrically connected to the second portion;
a third terminal electrically connected to the third portion,
a fourth terminal electrically connected to the fourth portion; and
a fifth terminal electrically connected to the first connecting conductive member.

### Technical Proposal 2

The magnetic head according to Technical proposal 1, wherein
the first reproducing element further includes:
a first conductive member provided between the first shield and the first magnetic member, the first conductive member being non-magnetic; and
a second conductive member provided between the first magnetic member and the second shield, the second conductive member being non-magnetic,
the first conductive member electrically connects the first shield to the first portion,
the second conductive member electrically connects the second shield to the second portion,
the first terminal is electrically connected to the first portion via the first shield and the first conductive member, and
the second terminal is electrically connected to the second portion via the second shield and the second conductive member.

### Technical Proposal 3

The magnetic head according to Technical proposal 2, wherein
the first reproducing element further includes:
a third conductive member provided between the third shield and the first magnetic member, the third conductive member being non-magnetic, and
a fourth conductive member provided between the first magnetic member and the fourth shield, the fourth conductive member being non-magnetic,
the third conductive member electrically connects the third shield to the third portion,
the fourth conductive member electrically connects the fourth shield to the fourth portion,
the third terminal is electrically connected to the third portion via the third shield and the third conductive member, and
the fourth terminal is electrically connected to the fourth portion via the fourth shield and the fourth conductive member.

### Technical Proposal 4

The magnetic head according to Technical proposal 2 or 3, wherein
a direction from the first conductive member to the first connecting conductive member crosses a direction from the first conductive member to the second conductive member.

### Technical Proposal 5

The magnetic head according to any one of Technical proposals 1-4, wherein
in the first direction, the third shield is between a part of the first shield and a part of the second shield, and
in the first direction, the fourth shield is between another part of the first shield and another part of the second shield.

### Technical Proposal 6

The magnetic head according to any one of Technical proposals 1-5, wherein
a first voltage between the first terminal and the second terminal is configured to change in response to a magnetic field to be detected when a current flows between the third terminal and the fourth terminal.

### Technical Proposal 7

The magnetic head according to Technical proposal 6, wherein
a second voltage between the first terminal and the fifth terminal is configured to change in response to the magnetic field to be detected when the current flows between the third terminal and the fourth terminal.

### Technical Proposal 8

The magnetic head according to any one of Technical proposals 1-5, wherein
a first voltage between the third terminal and the fourth terminal is configured to change in response to a magnetic field to be detected when a current flows between the first terminal and the second terminal.

### Technical Proposal 9

The magnetic head according to Technical proposal 8, wherein
a second voltage between the third terminal and the fifth terminal is configured to change in response to the magnetic field to be detected when the current flows between the first terminal and the second terminal.

### Technical Proposal 10

The magnetic head according to any one of Technical proposals 6-9, wherein
the first reproducing element is configured to face a magnetic recording medium,
the magnetic recording medium includes a first recording region and a second recording region,
a direction from the first recording region to the second recording region is along the first direction or the second direction, and
the magnetic field to be detected depends on a state of the first recording region and a state of the second recording region.

### Technical Proposal 11

The magnetic head according to any one of Technical proposals 1-5, wherein
the first reproducing element further includes:
a second connecting conductive member electrically connected to the first magnetic member, the second connecting conductive member being non-magnetic; and
a sixth terminal electrically connected to the second connecting conductive member, and
a direction from the first connecting conductive member to the second connecting conductive member crosses the third direction.

### Technical Proposal 12

The magnetic head according to Technical proposal 11, wherein
a third voltage between the first terminal and the sixth terminal is configured to change in response to a magnetic field to be detected when a current flows between the third terminal and the fourth terminal.

### Technical Proposal 13

The magnetic head according to Technical proposal 11, wherein
a third voltage between the third terminal and the sixth terminal is configured to change in response to a magnetic field to be detected when a current flows between the first terminal and the second terminal.

### Technical Proposal 14

The magnetic head according to Technical proposal 12 or 13, wherein
the first reproducing element is configured to face a magnetic recording medium,
the magnetic recording medium includes a first recording region and a second recording region,
a direction from the first recording region to the second recording region is along the first direction or the second direction, and
the magnetic field to be detected depends on a state of the first recording region and a state of the second recording region.

### Technical Proposal 15

The magnetic head according to any one of Technical proposals 1-14, wherein
the first connecting conductive member overlaps a part of the first magnetic member in the third direction.

### Technical Proposal 16

The magnetic head according to any one of Technical proposals 1-15, wherein
the first reproducing element further includes a second magnetic member, and
a direction from the first magnetic member to the second magnetic member is along the third direction.

### Technical Proposal 17

The magnetic head according to any one of Technical proposals 1-16, wherein
a length of the first magnetic member along the third direction is longer than a length of the first magnetic member along the second direction.

### Technical Proposal 18

The magnetic head according to any one of Technical proposals 1-17, wherein
the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

### Technical Proposal 19

The magnetic head according to any one of Technical proposals 1-18, wherein
the first connecting conductive member includes at least one selected from the group consisting of Cu, Au, Ag, Pt, Al, Pd, Ta, Ru, Hf, W, Mo, Ir, Cr, Tb, and Rh.

### Technical Proposal 20

A magnetic recording device, comprising:
the magnetic head according to any one of Technical proposals 1-9; and
a magnetic recording medium,
the reproducing section being configured to reproduce information recorded on the magnetic recording medium.

According to the embodiment, a magnetic head and a magnetic recording device can be provided that can improve characteristics.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic layers, conductive members, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section including a first reproducing element,
the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield, the first magnetic member including a first portion, a second portion, a third portion, and a fourth portion, the first portion being between the first shield and the second shield in the first direction, the second portion being between the first portion and the second shield in the first direction, the third portion being between the third shield and the fourth shield in the second direction, and the fourth portion being between the third portion and the fourth shield in the second direction;
a first connecting conductive member electrically connected to the first magnetic member, a direction from at least a part of the first magnetic member to the first connecting conductive member being along a third direction crossing a plane including the first direction and the second direction;
a first terminal electrically connected to the first portion;
a second terminal electrically connected to the second portion;
a third terminal electrically connected to the third portion,
a fourth terminal electrically connected to the fourth portion; and
a fifth terminal electrically connected to the first connecting conductive member.

2. The magnetic head according to claim 1, wherein
the first reproducing element further includes:
a first conductive member provided between the first shield and the first magnetic member, the first conductive member being non-magnetic; and
a second conductive member provided between the first magnetic member and the second shield, the second conductive member being non-magnetic,
the first conductive member electrically connects the first shield to the first portion,
the second conductive member electrically connects the second shield to the second portion,
the first terminal is electrically connected to the first portion via the first shield and the first conductive member, and
the second terminal is electrically connected to the second portion via the second shield and the second conductive member.

3. The magnetic head according to claim 2, wherein
the first reproducing element further includes:
a third conductive member provided between the third shield and the first magnetic member, the third conductive member being non-magnetic, and
a fourth conductive member provided between the first magnetic member and the fourth shield, the fourth conductive member being non-magnetic,
the third conductive member electrically connects the third shield to the third portion,
the fourth conductive member electrically connects the fourth shield to the fourth portion,
the third terminal is electrically connected to the third portion via the third shield and the third conductive member, and
the fourth terminal is electrically connected to the fourth portion via the fourth shield and the fourth conductive member.

4. The magnetic head according to claim 2, wherein
a direction from the first conductive member to the first connecting conductive member crosses a direction from the first conductive member to the second conductive member.

5. The magnetic head according to claim 1, wherein
in the first direction, the third shield is between a part of the first shield and a part of the second shield, and
in the first direction, the fourth shield is between another part of the first shield and another part of the second shield.

6. The magnetic head according to claim 1, wherein
a first voltage between the first terminal and the second terminal is configured to change in response to a magnetic field to be detected when a current flows between the third terminal and the fourth terminal.

7. The magnetic head according to claim 6, wherein
a second voltage between the first terminal and the fifth terminal is configured to change in response to the magnetic field to be detected when the current flows between the third terminal and the fourth terminal.

8. The magnetic head according to claim 1, wherein
a first voltage between the third terminal and the fourth terminal is configured to change in response to a magnetic field to be detected when a current flows between the first terminal and the second terminal.

9. The magnetic head according to claim 8, wherein
a second voltage between the third terminal and the fifth terminal is configured to change in response to the magnetic field to be detected when the current flows between the first terminal and the second terminal.

10. The magnetic head according to claim 6, wherein
the first reproducing element is configured to face a magnetic recording medium,
the magnetic recording medium includes a first recording region and a second recording region,
a direction from the first recording region to the second recording region is along the first direction or the second direction, and
the magnetic field to be detected depends on a state of the first recording region and a state of the second recording region.

11. The magnetic head according to claim 1, wherein
the first reproducing element further includes:
a second connecting conductive member electrically connected to the first magnetic member, the second connecting conductive member being non-magnetic; and
a sixth terminal electrically connected to the second connecting conductive member, and
a direction from the first connecting conductive member to the second connecting conductive member crosses the third direction.

12. The magnetic head according to claim 11, wherein
a third voltage between the first terminal and the sixth terminal is configured to change in response to a magnetic field to be detected when a current flows between the third terminal and the fourth terminal.

13. The magnetic head according to claim 11, wherein
a third voltage between the third terminal and the sixth terminal is configured to change in response to a magnetic field to be detected when a current flows between the first terminal and the second terminal.

14. The magnetic head according to claim 12, wherein
the first reproducing element is configured to face a magnetic recording medium,
the magnetic recording medium includes a first recording region and a second recording region,
a direction from the first recording region to the second recording region is along the first direction or the second direction, and
the magnetic field to be detected depends on a state of the first recording region and a state of the second recording region.

15. The magnetic head according to claim 1, wherein
the first connecting conductive member overlaps a part of the first magnetic member in the third direction.

16. The magnetic head according to claim 1, wherein
the first reproducing element further includes a second magnetic member, and
a direction from the first magnetic member to the second magnetic member is along the third direction.

17. The magnetic head according to claim 1, wherein
a length of the first magnetic member along the third direction is longer than a length of the first magnetic member along the second direction.

18. The magnetic head according to claim 1, wherein
the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

19. The magnetic head according to claim 1, wherein
the first connecting conductive member includes at least one selected from the group consisting of Cu, Au, Ag, Pt, Al, Pd, Ta, Ru, Hf, W, Mo, Ir, Cr, Tb, and Rh.

20. A magnetic recording device, comprising:
the magnetic head according to claim 1; and
a magnetic recording medium,
the reproducing section being configured to reproduce information recorded on the magnetic recording medium.
